(19) United States
(12) Patent Application Publication
(10) Pub. No.: US 2025/0283493 A1
(43) Pub. Date: Sep. 11, 2025

(54) Z-CLIP WITH ANGLED BASE FOR DEPTH ALIGNMENT

(71) Applicant: Patrick DORAN, Petaluma, CA (US)

(72) Inventor: Patrick DORAN, Petaluma, CA (US)

(21) Appl. No.: 18/783,314

(22) Filed: Jul. 24, 2024

Related U.S. Application Data
(63) Continuation of application No. 18/599,939, filed on Mar. 8, 2024, now Pat. No. 12,085,104.

(51) Int. Cl. F16B 2/14; F16B 5/12

(52) U.S. Cl. CPC F16B 2/14; F16B 5/123

(57) ABSTRACT

A z-clip has a back side member that is angled relative to the front face. A wedge is designed to be used with the z-clip, where the wedge has an angle that matches the angle of the back side member of the z-clip. Thus, the wedge can be slid under the z-clip at a desired position to angle the z-clip in its use position, while allowing the z-clip to be horizontally offset from the wall. The system provided by the z-clip and wedge can quickly and easily set z-clips on a wall to a vertical reference plane, thus providing an easy fit for a wall panel to be subsequently attached thereto. Further provided are quick offset blocks that can attach to ends of each row of z-clips to provide a way for spanning a string therebetween, thus providing a vertical reference line for aligning z-clips along the vertical reference line.

### CROSS-REFERENCE TO RELATED APPLICATIONS

This application is a continuation of U.S. patent application Ser. No. 18/599,939, filed Mar. 8, 2024, the contents of which are herein incorporated by reference.

### BACKGROUND OF THE INVENTION

### 1. Field of the Invention

Embodiments of the invention relate generally to brackets and mounting systems. More particularly, embodiments of the invention relate to a z-clip bracket that can easily adjust its mounted distance horizontally from a wall.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Architectural panels are well known in the building trade and are often used to cover existing wall surfaces to create a specific design element or effect.

It is well known to hang architectural panels using panel clips, also commonly referred to as panel “Z” clips, or simply z-clips, which have lower portion for placement against a wall, and an upper portion, extending upward and spaced apart from the wall. In use, a first z-clip can be attached to the wall. A second z-clip can be attached to the back of the panel such that it has an upper portion attached to the back of the panel, and a lower portion extending downward and spaced apart from the back of the panel. The panel is hung attached to the wall by placing the downward-facing, offset portion of the z-clip on the back of the panel into the upward-facing offset portion of the z-clip attached to the wall.

Panel installers need to insure that all panels will be aligned in the vertical plane so that the face of each panel will be aligned with the face of every other panel. Since the surface of a wall is not typically vertically aligned over the entire surface of the wall, a plurality of flat shims are combined to build out the surface of the wall to a vertical reference, typically at the location of each wall stud where each panel clip is to be located.

The shims are installed such that the outward-facing surface of each shimmed area is in vertical alignment with the outward-facing surface of every other shimmed area. The shims are typically secured in place by nails, screws and/or glue, in accordance with the installer's preference.

The process of shimming out the z-clips to a vertical reference plane can prove difficult and time consuming. Further, the installer would need a plurality of shims of varying sizes to ensure the z-clips confirm to the vertical reference plane.

In view of the foregoing, there is a need for a convenient and easy-to-use system and method of applying z-clips to a wall and adjusting their horizontal offset from the wall to provide a vertical reference plane.

### SUMMARY OF THE INVENTION

Embodiments of the present invention aim to solve the aforementioned problems in conventional mounting systems by providing a z-clip that can be easily horizontally adjusted with respect to the wall on which it is mounted.

Embodiments of the present invention provide a mounting system comprising a bracket, the bracket including a main body having a main body front side and a main body back side; a lower portion, extending from and formed integrally with the main body, having at least one hole therein for a fastener to extend there through for attaching the bracket to a surface, the lower portion having a back side continuous and linear with the main body back side, the back side of the lower portion and the main body back side defining a bracket back side; an upper portion extending in a direction opposite the lower leg, wherein a back side of the upper leg is spaced away from the surface when the lower leg is attached to the surface, wherein the bracket back side is disposed non-parallel to a front side plane defined by the front side of the upper portion and the main body front side.

Embodiments of the present invention provide a mounting system comprising a bracket and a wedge. The bracket comprising a main body having a main body front side and a main body back side; a lower portion, extending from and formed integrally with the main body, having at least one hole therein for a fastener to extend there through for attaching the bracket to a surface, the lower portion having a back side continuous and linear with the main body back side, the back side of the lower portion and the main body back side defining a bracket back side; an upper portion extending in a direction opposite the lower leg, wherein a back side of the upper leg is spaced away from the surface when the lower leg is attached to the surface, wherein the bracket back side is disposed non-parallel to a front side plane defined by the front side of the upper portion and the main body front side. The wedge comprising a wedge back side configured to be positioned against the surface, with at least a portion of the wedge back side being disposed between the bracket and the wall; and a wedge front side configured to be slidable along the bracket back side, wherein the wedge back side and the wedge front side form a wedge angle to provide a continuously increasing thickness along a length of the wedge, from a tip end to a distal end thereof; and a position of the wedge relative to the bracket provides a continuously variable horizontal displacement of the bracket from the surface.

Embodiments of the present invention provide a method of attaching one or more brackets on a surface in a single vertical reference plane comprising placing the one or more brackets horizontally along the surface in a first row, each of the one or more brackets comprising a main body having a main body front side and a main body back side, a lower portion, extending from and formed integrally with the main body, the lower portion having a back side continuous and linear with the main body back side, the back side of the lower portion and the main body back side defining a bracket back side, an upper portion extending in a direction opposite the lower leg, wherein a back side of the upper leg is spaced away from the surface when the lower leg is attached to the surface, wherein the bracket back side is disposed non-parallel to a front side plane defined by the front side of the upper portion and the main body front side, and placing one or more wedges between each of the one or more brackets and the surface, each of the one or more wedges comprising a wedge back side positioned against the surface, with at least a portion of the wedge back side being disposed between the bracket and the wall; and a wedge front side slidable along the bracket back side, wherein the wedge back side and the wedge front side form a wedge angle to provide a continuously increasing thickness along a length of the wedge, from a tip end to a distal end thereof; and sliding each of the one or more wedges to provide a horizontal displacement of each of the one or more brackets to position each of the one or more brackets along the single vertical reference plane.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a side view of a bracket according to an exemplary embodiment of the present invention;

FIG. 2 illustrates a side view of a wedge usable with the bracket of FIG. 1;

FIG. 3 illustrates a top view of the wedge of FIG. 2;

FIG. 4 illustrates an engagement of the bracket of FIG. 1 with the wedge of FIG. 2;

FIG. 5 illustrates a side view of the bracket of FIG. 1, showing one example of measurements of the bracket applied thereto;

FIG. 6 illustrates a side view of the wedge of FIG. 2, showing one example of measurements of the wedge applied thereto;

FIG. 7 illustrates a side view of the wedge of FIG. 2, showing another example of measurements of the wedge applied thereto;

FIG. 8 illustrates a top view of the wedge of FIG. 2, showing one example of measurements of the wedge applied thereto;

FIG. 9 illustrates the bracket of FIG. 1 and the wedge of FIG. 2 used to hang a hanging structure, according to an exemplary embodiment of the present invention;

FIG. 10 illustrates the bracket of FIG. 1 and the wedge of FIG. 6 used to provide a minimal or no horizontal displacement of the bracket from the wall;

FIG. 11 illustrates the bracket of FIG. 1 and the wedge of FIG. 6 used to provide a maximum horizontal displacement of the bracket from the wall;

FIG. 12 illustrates the bracket of FIG. 1 and the wedge of FIG. 7 used to provide a minimal or no horizontal displacement of the bracket from the wall;

FIG. 13 illustrates the bracket of FIG. 1 and the wedge of FIG. 7 used to provide a maximum horizontal displacement of the bracket from the wall;

FIG. 14A illustrates a quick offset block for horizontally aligning the bracket(s) of FIG. 1 along a wall;

FIG. 14B illustrates a side view of a matching offset block for horizontally aligning the bracket(s) of FIG. 1 along a wall;

FIG. 14C illustrates a front view of the matching offset block of FIG. 14B; and

FIG. 15 illustrates a schematic representation of the bracket of FIG. 1 applied to a wall, with the quick offset blocks applied thereto and a string extending from end to end of each row of brackets, according to an exemplary method of the present invention; and

FIG. 16 illustrates an exemplary method of using the bracket of FIG. 1, the wedge of FIG. 2 and the quick offset block of FIG. 14A to mount a bracket on a wall in a single vertical reference plane.

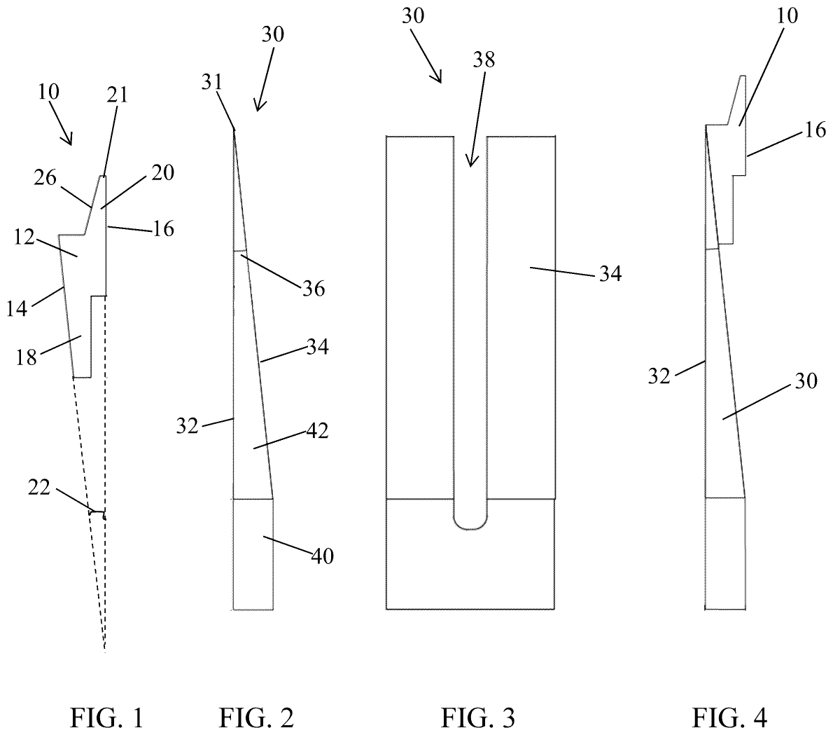

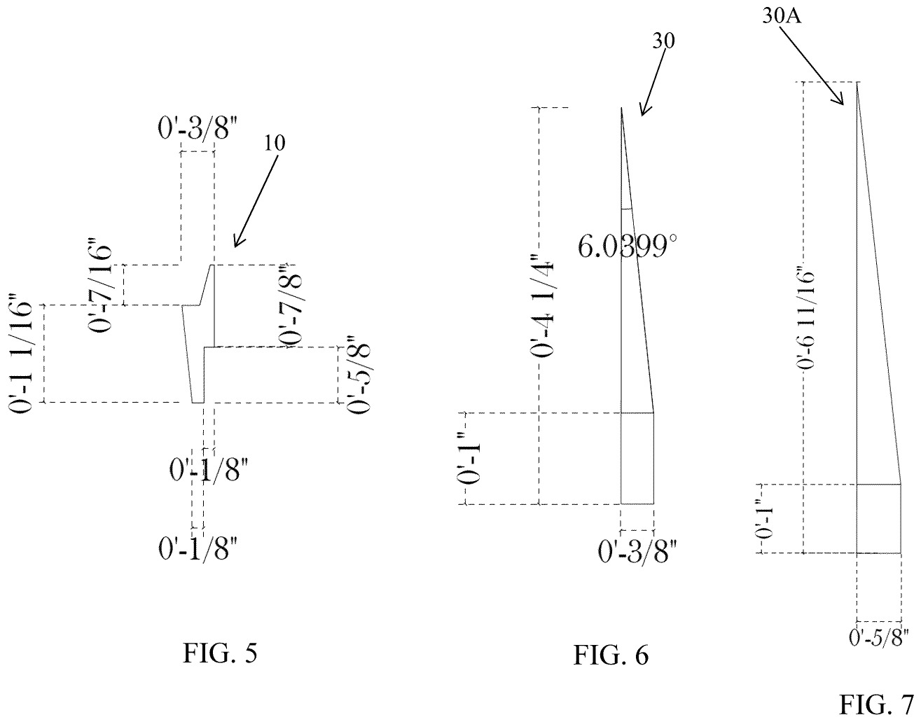

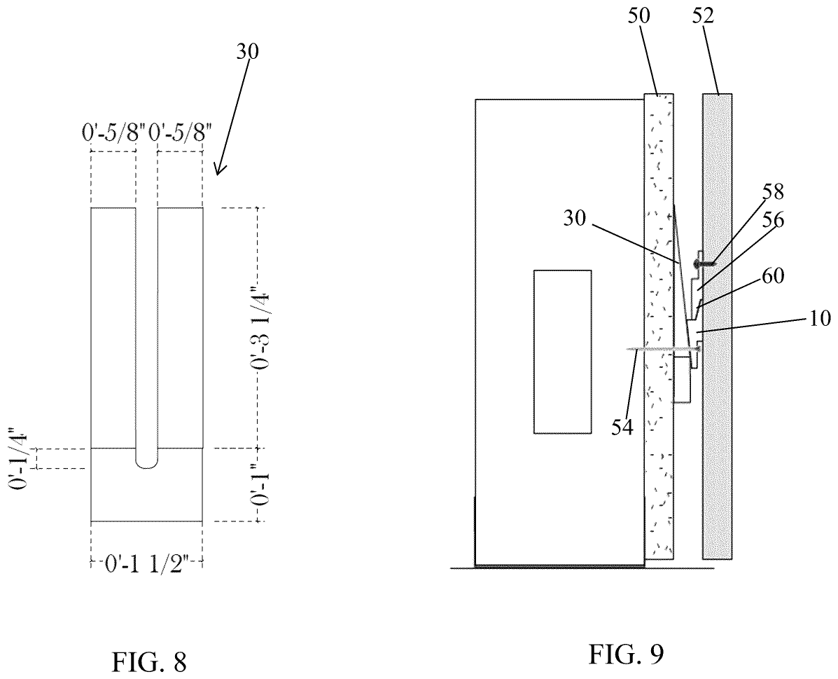

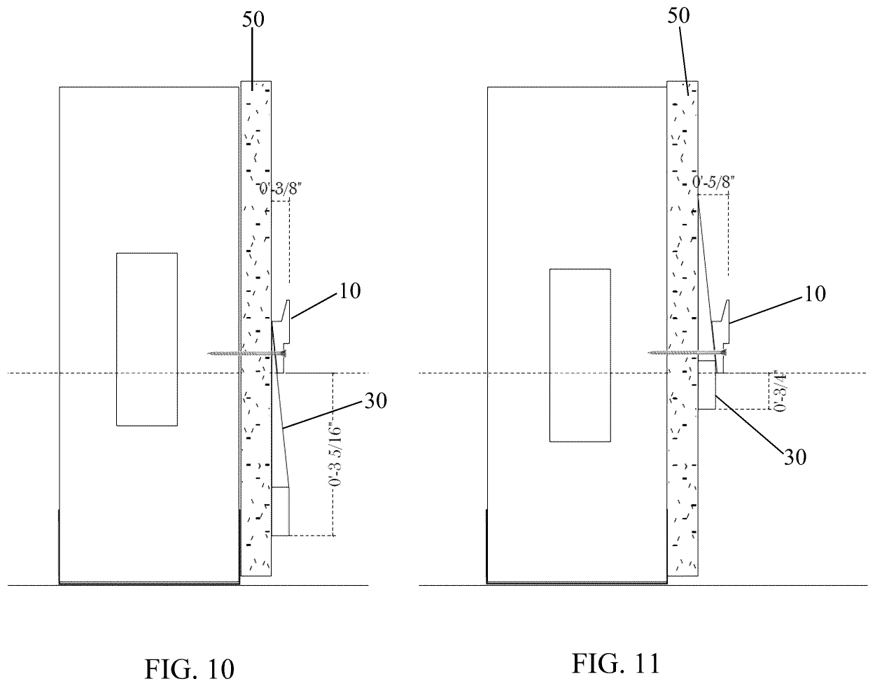

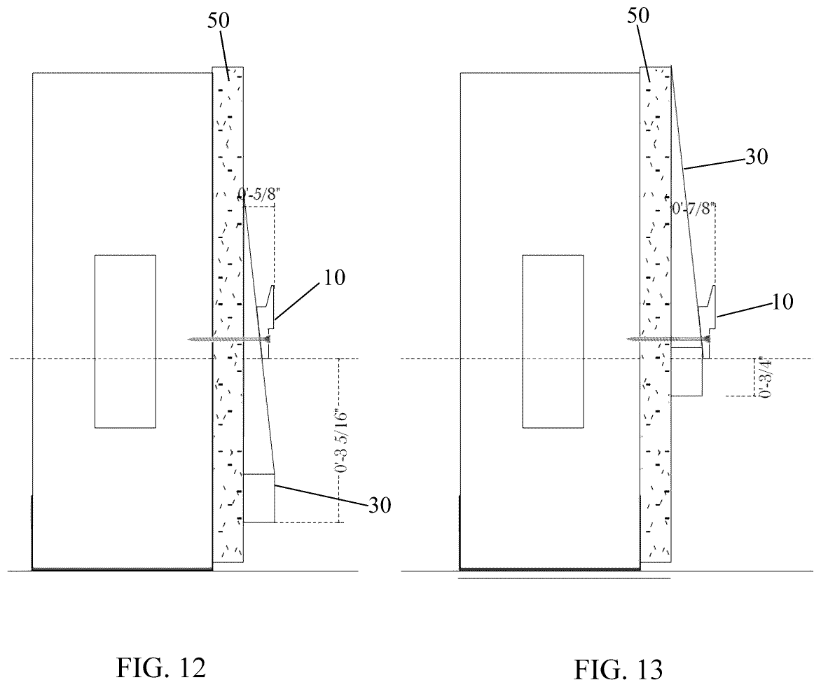

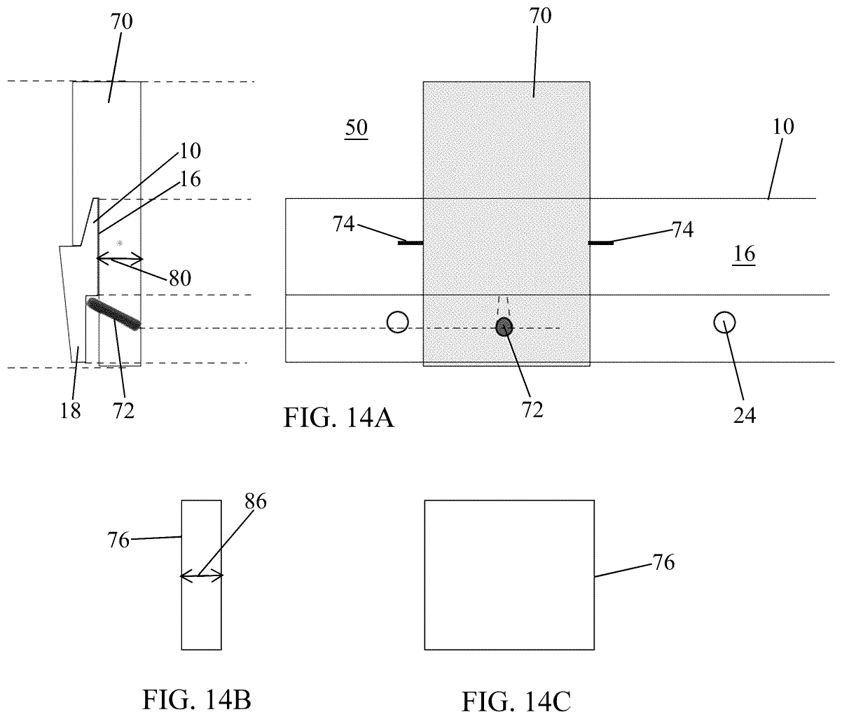

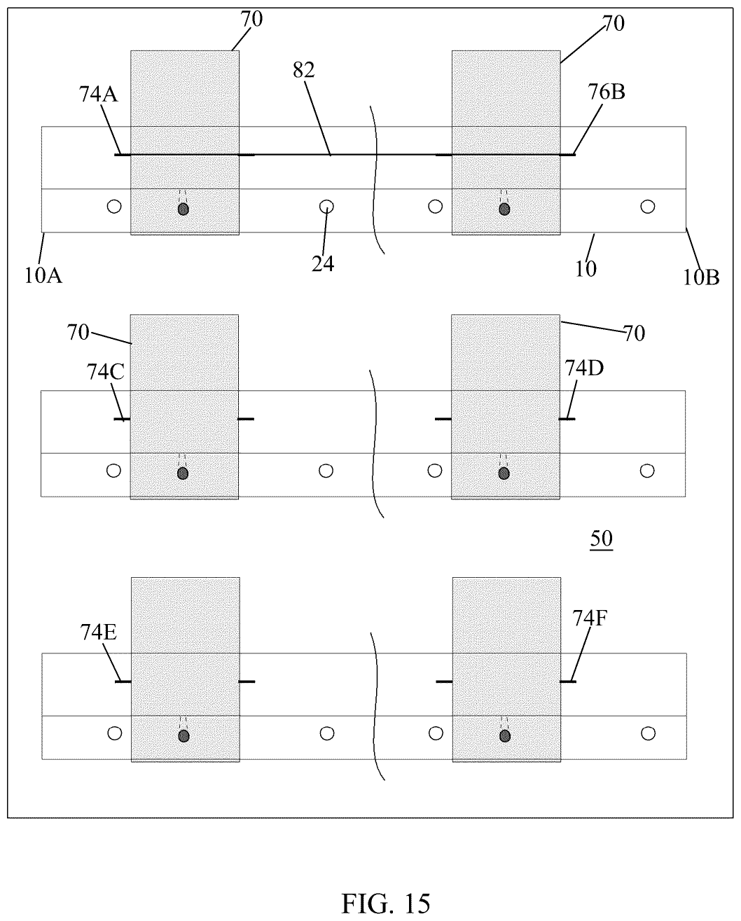

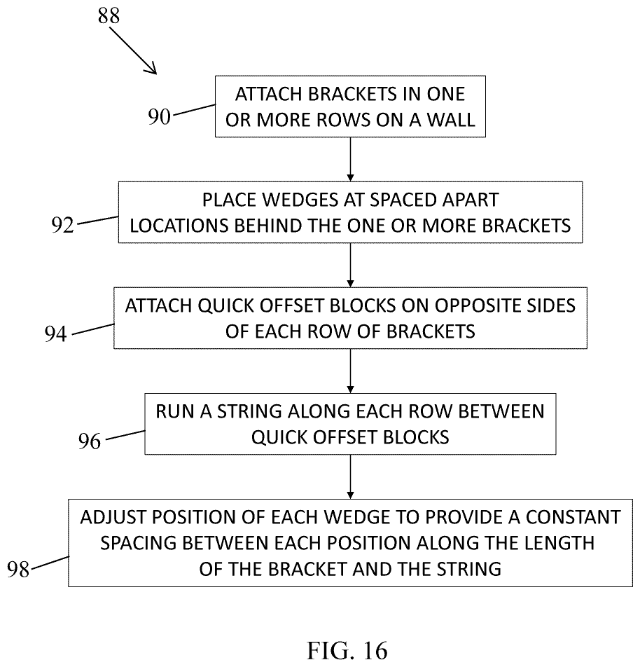

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

1. A mounting system comprising a bracket, the bracket including:
a main body having a main body front side and a main body back side;
a lower portion, extending from and formed integrally with the main body, the lower portion having a lower portion front side and a back side, the lower portion front side and the back side defining non-parallel planes, the back side being continuous and linear with the main body back side, the back side of the lower portion and the main body back side defining a bracket back side configured for placement against a surface;
an upper portion extending in a direction opposite the lower portion, wherein a back side of the upper portion is spaced away from the surface when the lower portion is attached to the surface; and
a quick offset block, the quick offset block being removably attachable to the bracket and having a front face that is parallel to and spaced apart from the front side plane when the quick offset block is attached to the bracket.

2. The mounting system of claim 1, wherein the bracket back side forms a bracket angle with the front side plane from about 4 degrees to about 10 degrees.

3. The mounting system of claim 2, further comprising a wedge, the wedge comprising:
a wedge back side configured to be positioned against the surface, with at least a portion of the wedge back side being disposed between the bracket back side and the wall; and
a wedge front side configured to be slidable along the bracket back side, wherein
the wedge back side and the wedge front side form a wedge angle to provide a continuously increasing thickness along a length of the wedge, from a tip end to a distal end thereof.

4. The mounting system of claim 3, wherein the wedge further includes a non-sloped portion, at the distal end thereof, where the wedge front side is parallel to the wedge front side.

5. The mounting system of claim 4, wherein the wedge further includes a slot extending along a portion of the length of the wedge, from the tip end and ending at or into the non-sloped portion, the slot extending through the wedge, from the wedge back side to the wedge front side.

6. The mounting system of claim 5, wherein the slot aligns with a hole in the tapered lower portion of the bracket.

7. The mounting system of claim 3, wherein the wedge angle matches the bracket angle.

8. The mounting system of claim 3, wherein the front side plane is parallel to the surface when the wedge is positioned between the surface and the bracket.

9. (canceled)

10. The mounting system of claim 1, wherein the quick offset block includes a tie arm extending outward from opposite sides thereof.

11. The mounting system of claim 10, wherein the tie arm is positioned in front of the front side plane when the quick offset block is positioned on the bracket.

12. A mounting system comprising:
a bracket comprising:
a main body having a main body front side and a main body back side;
a lower portion, extending from and formed integrally with the main body, the lower portion having a back side continuous and linear with the main body back side, the back side of the lower portion and the main body back side defining a bracket back side configured for placement against a surface;
an upper portion extending in a direction opposite the lower portion, wherein a back side of the upper portion is spaced away from the surface when the lower portion is attached to the surface, wherein
the bracket back side is disposed non-parallel to a front side plane defined by a front side of the upper portion and the main body front side; and
a wedge comprising:
a wedge back side configured to be positioned against the surface, with at least a portion of the wedge back side being disposed between the bracket back side and the wall; and
a wedge front side configured to be slidable along the bracket back side, wherein:
the wedge back side and the wedge front side form a wedge angle to provide a continuously increasing thickness along a length of the wedge, from a tip end to a distal end thereof; and
a position of the wedge relative to the bracket provides a continuously variable horizontal displacement of the bracket from the surface; and
a quick offset block, wherein:
the quick offset block being removably attachable to the bracket and having a front face that is parallel to and spaced apart from the front side plane when the quick offset block is attached to the bracket;
the quick offset block includes a tie arm extending outward from opposite sides thereof; and
the tie arm is positioned in front of the front side plane when the quick offset block is positioned on the bracket.

13. The mounting system of claim 12, wherein:
the bracket back side forms a bracket angle with the front side plane from about 4 degrees to about 10 degrees; and
the wedge angle matches the bracket angle.

14. The mounting system of claim 12, wherein the wedge further includes a slot extending along a portion of the length of the wedge, from the tip end and ending at or into the non-sloped portion, the slot extending through the wedge, from the wedge back side to the wedge front side.

15. The mounting system of claim 12, wherein the front side plane is parallel to the surface when the wedge is positioned between the surface and the bracket.

16. (canceled)

17. A method of attaching one or more brackets on a surface in a single vertical reference plane, the method comprising:
placing the one or more brackets horizontally along the surface in a first row, each of the one or more brackets comprising:
a main body having a main body front side and a main body back side;
a lower portion, extending from and formed integrally with the main body, the lower portion having a back side continuous and linear with the main body back side, the back side of the lower portion and the main body back side defining a bracket back side, the lower portion having a hole with a fastener extending therethrough for attaching the one or more brackets on the surface;
an upper portion extending in a direction opposite the lower portion, wherein a back side of the upper portion is spaced away from the surface when the lower portion is attached to the surface, wherein
the bracket back side is disposed non-parallel to a front side plane defined by a front side of the upper portion and the main body front side; and
placing one or more wedges between each of the one or more brackets and the surface, each of the one or more wedges comprising:
a wedge back side positioned against the surface, with at least a portion of the wedge back side being disposed between the bracket and the wall;
a wedge front side slidable along the bracket back side; and
a slot extending along a portion of the length of the wedge, from a tip end thereof, the slot extending through the wedge, from the wedge back side to the wedge front side, wherein:
the wedge back side and the wedge front side form a wedge angle to provide a continuously increasing thickness along a length of the wedge, from a tip end to a distal end thereof;
sliding each of the one or more wedges, with the slot aligned with the fastener, to provide a horizontal displacement of each of the one or more brackets to position each of the one or more brackets along the single vertical reference plane;
removably attaching a quick offset block to each of the one or more brackets, wherein the quick offset block has a front face that is parallel to and spaced apart from the front side plane; and
extending a string from a tie arm of a first quick offset block at one side of the first row to a second quick offset block at an opposite side of the first row; and
using the string to align the one or more brackets in the single vertical reference plane by adjusting a sliding position of each of the plurality of wedges behind each of the one or more brackets.

18. The method of claim 17, wherein:
the bracket back side forms a bracket angle with the front side plane from about 4 degrees to about 10 degrees; and
the wedge angle matches the bracket angle.

19. The method of claim 17, wherein the wedge aligns the upper portions of each of the one or more brackets at a uniform horizontal distance from the surface.

20. (canceled)
